(19) United States
(12) Patent Application Publication
(10) Pub. No.: US 2009/0013117 A1
(43) Pub. Date: Jan. 8, 2009

(54) SYSTEM AND METHOD FOR GENERATING INTERRUPT

(75) Inventor: Chien-Hsing Huang, Hsin-Chu (TW)

Correspondence Address: J C PATENTS, INC., 4 VENTURE, SUITE 250, IRVINE, CA, 92618, US

(73) Assignee: IC PLUS CORP., Hsin-Chu (TW)

(21) Appl. No.: 11/861,859

(22) Filed: Sep. 26, 2007

(30) Foreign Application Priority Data
Jul. 5, 2007 (TW) 96124487

(51) Int. Cl. G06F 13/24

(52) U.S. Cl. 710/260

(57) ABSTRACT

A system and a method for generating an interrupt are provided. In the interrupt generating method, a time-out mechanism is executed by a second network component of a computer system after a packet processing action is finished. An interrupt is generated by the second network component only if a first network component of the computer system does not execute a polling action during a predefined period after the time-out mechanism is processed. Thus, it is not necessary to generate the interrupt every time after processing a network packet, so that less interrupts are generated and accordingly the loading of the computer system is reduced. Moreover, the reaction time of the computer system is kept to ensure the efficiency of the computer system.

### CROSS-REFERENCE TO RELATED APPLICATION

This application claims the priority benefit of Taiwan application serial no. 96124487, filed on Jul. 5, 2007. All disclosure of the Taiwan application is incorporated herein by reference.

### BACKGROUND OF THE INVENTION

1. Field of the Invention

The present invention relates to a system and a method for generating an interrupt. More particularly, the present invention relates to a system and a method for generating an interrupt for processing a network packet.

2. Description of Related Art

In a general architecture of a computer system, a peripheral device notifies the processor of the computer system to suspend a current process by issuing an interrupt so that the processor can call an interrupt processing routine to execute the requirement of the peripheral device. Take transmitting a network packet as an example, referring to FIG. 1, when a processor 110 is about to transmit the network packet, the processor 110 calls a network card driver 120 to transmit the network packet to a network card 130 first, and then the network card 130 executes the action of transmitting the network packet. The network card 130 notifies the processor 110 that the network packet has been transmitted by generating an interrupt every time after the network card 130 has transmitted a network packet. Moreover, the network card 130 also notifies the processor 110 by generating an interrupt when receiving a network packet, so that the processor 110 executes an interrupt processing routine in the network card driver 120 to transmit the network packet to an upper level of the computer system to be processed.

However, the interrupts generated by transmitting or receiving network packets may affect the efficiency of the entire computer system. Various solutions have been provided by many network component manufacturers. For example, a network card developed by 3COM only generates an interrupt after transmitting or receiving a particular number of network packets, so as to reduce the number of interrupts and lessen the loading of the computer system. However, it has to be noted that the network card will not issue any interrupt for a long time if the number of transmitted/received network packets does not reach the particular number. As a result, the reaction time of the computer system will be affected.

On the other hand, even though the affection of generating interrupts to a computer system can be avoided by turning off the interrupt mechanism and regularly checking whether the network packets have been processed with the network card driver, the reaction time of the computer system may also be slowed down in this circumstance.

As described above, how to reduce the number of interrupts so that lessening the loading of a computer system without affecting the reaction time of the computer system is one of the major subjects of network component manufacturers.

### SUMMARY OF THE INVENTION

Accordingly, the present invention is directed to an interrupt generating system, wherein the number of interrupts generated for processing a large quantity of network packets is reduced and accordingly the efficiency of a computer system is increased.

The present invention is further directed to an interrupt generating method. When processing a network packet, both of a time-out mechanism and a polling action are used for determining whether an interrupt is generated or not, so that the situation of generating the interrupt every time after processing the network packet can be avoided.

The present invention provides an interrupt generating system including a first network component and a second network component. The first network component issues a packet processing signal and executes a polling action at a particular time. The second network component coupled to the first network component receives the packet processing signal and executes a packet processing action accordingly, and the second network component starts executing a time-out mechanism when it finishes executing the packet processing action. The second network component issues an interrupt if the first network component does not execute the polling action during a predefined period after the time-out mechanism is started.

According to an embodiment of the present invention, in the interrupt generating system, the particular time includes the time after the first network component has issued n packet processing signals, wherein n is a positive integer, and the packet processing signal contains the address or length of a network packet.

According to an embodiment of the present invention, in the interrupt generating system, the second network component further includes a storage component for recording the serial number of a last network packet processed by the second network component.

According to an embodiment of the present invention, in the interrupt generating system, the polling action executed by the first network component includes reading the content of the storage component.

According to an embodiment of the present invention, in the interrupt generating system, the second network component further updates the content of the storage component with the serial number of the last network packet after it finishes executing the packet processing action.

According to an embodiment of the present invention, in the interrupt generating system, the packet processing action includes transmitting a network packet.

According to an embodiment of the present invention, in the interrupt generating system, the time-out mechanism includes counting down a waiting time, and the predefined period includes the time for counting down the waiting time to 0.

According to an embodiment of the present invention, in the interrupt generating system, the second network component stops executing the time-out mechanism if the first network component executes the polling action during the predefined period.

According to an embodiment of the present invention, in the interrupt generating system, the first network component includes a network card driver, and the second network component includes a network card.

The present invention further provides an interrupt generating method suitable for a computer system having a first network component and a second network component. According to the interrupt generating method, the second network component executes a time-out mechanism after it finishes executing a packet processing action. The second network component issues an interrupt if the first network component does not execute a polling action during a predefined period after the time-out mechanism is started.

According to an embodiment of the present invention, in the interrupt generating method, the first network component further issues a packet processing signal for driving the second network component to execute the packet processing action before it starts executing the time-out mechanism.

According to an embodiment of the present invention, in the interrupt generating method, the first network component further executes the polling action at a particular time, wherein the particular time includes the time after n packet processing signals have been issued, and n is a positive integer, and the packet processing signal contains the address or length of a network packet.

According to an embodiment of the present invention, in the interrupt generating method, the second network component further updates the serial number with a last network packet processed by the second network component after the second network component finishes executing the packet processing action.

According to an embodiment of the present invention, in the interrupt generating method, the polling action includes reading the serial number of the last network packet processed by the second network component.

According to an embodiment of the present invention, in the interrupt generating method, the packet processing action includes transmitting a network packet.

According to an embodiment of the present invention, in the interrupt generating method, the time-out mechanism includes counting down a waiting time, and the predefined period includes the time for counting down the waiting time to 0.

According to an embodiment of the present invention, in the interrupt generating method, the second network component stops executing the time-out mechanism if the first network component executes the polling action during the predefined period after the time-out mechanism is started.

According to an embodiment of the present invention, in the interrupt generating method, the first network component includes a network card driver, and the second network component includes a network card.

While processing network packets with the present invention, an interrupt is issued only when it has been too long that no polling action is executed, so that the number of generating interrupts is reduced and accordingly the efficiency of the computer system is improved.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional interrupt generating system.

FIG. 2 is a diagram of an interrupt generating system according to an embodiment of the present invention.

FIG. 3 is a flowchart of an interrupt generating method according to an embodiment of the present invention.

FIG. 4 is a state machine diagram of a second network component according to an embodiment of the present invention.

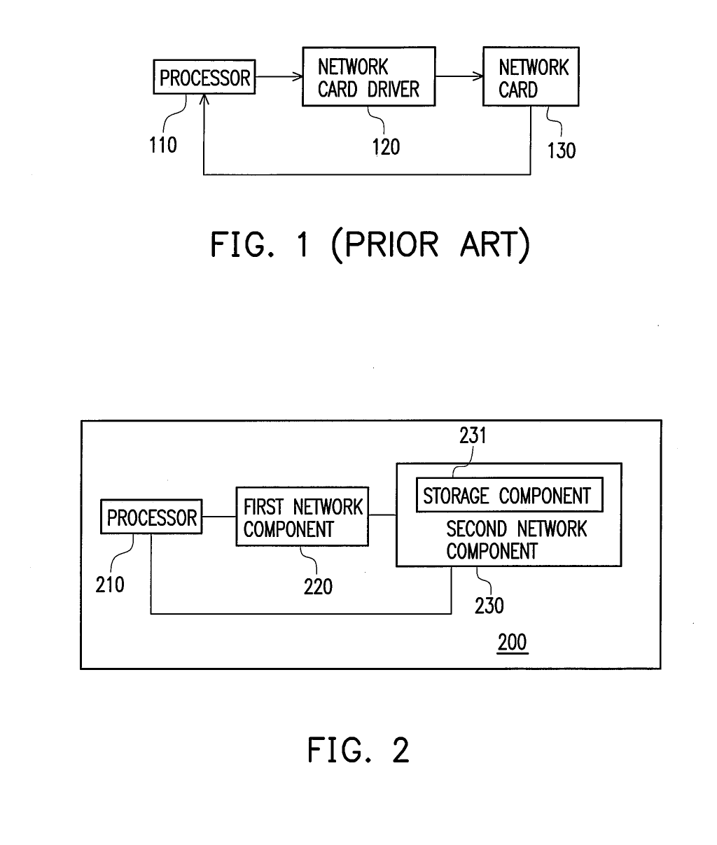

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Generally speaking, the efficiency of a computer system can be considerably improved if less interrupts are generated while transmitting or receiving network packets. Accordingly, the present invention provides a system and a method for generating an interrupt, wherein the number of interrupts is reduced without affecting the reaction time of the computer system. Embodiments of the present invention will be described in detail with reference to accompanying drawings.

FIG. 2 is a diagram of an interrupt generating system according to an embodiment of the present invention. Referring to FIG. 2, the computer system 200 includes a processor 210, a first network component 220, and a second network component 230. In the present embodiment, the first network component 220 is, for example, a network card driver, and the second network component 230 comprises a network card.

In the computer system 200, the first network component 220 issues a packet processing signal and executes a polling action at a particular time. The packet processing signal contains the serial number, address, or length of a network packet to be processed. Accordingly, when a network component receives the packet processing signal, the network component can process the network packet according to the information recorded in the packet processing signal. The polling action executed by the first network component 220 will be described in detail later on.

The second network component 230 coupled to the first network component 220 executes a corresponding packet processing action once it receives the packet processing signal from the first network component 220. After the packet processing action is completed, the second network component 230 starts to execute a time-out mechanism.

In the present embodiment, the second network component 230 further includes a storage component 231 for recording the serial number of the last network packet processed by the second network component 230, wherein the storage component 231 may be a register in a network card. The polling action executed by the first network component 220 at a particular time is, for example, reading the content of the storage component 231. To reduce the time required for reading the storage component 231, a faster input/output bus (for example, a memory bus) can be adopted so that the processing time is made close to the time for reading the memory and accordingly the processor 210 is held up less time.

In the present embodiment, if the first network component 220 does not execute the polling action during a predefined period after the second network component 230 starts executing the time-out mechanism, the second network component 230 then issues an interrupt to the processor 210, and the processor 210 then calls a corresponding interrupt processing routine for executing subsequent processing. That is, the second network component 230 may issue an interrupt once if the first network component 220 does not execute the polling action for a long time.

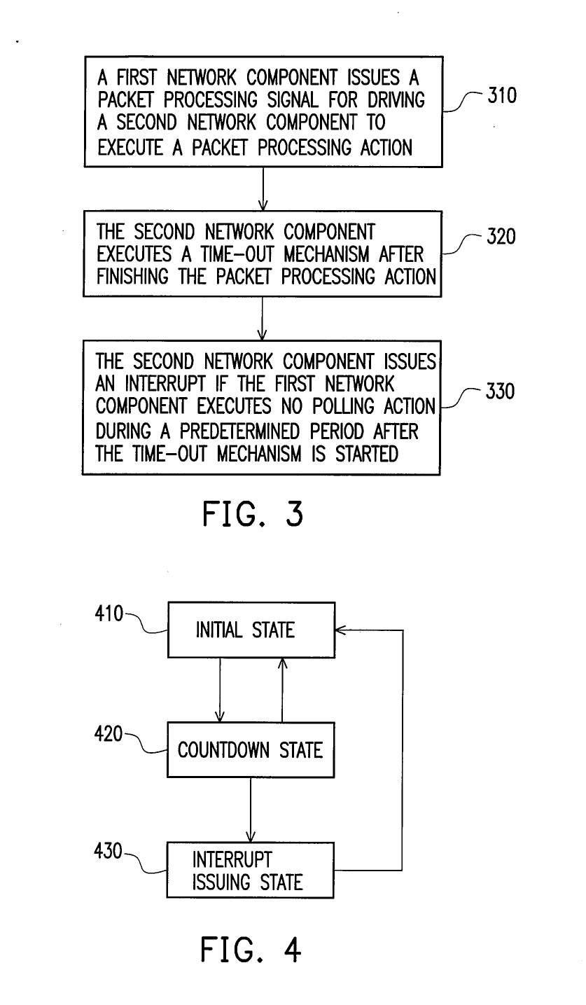

In order to illustrate the detailed operations of the interrupt generating system, another embodiment of the present invention will be further described as follow. In the following embodiment, the transmission of a network packet is taking as an example of the packet processing action. FIG. 3 is a flowchart of an interrupt generating method according to an embodiment of the present invention. Please refer to both FIG. 2 and FIG. 3 for following description.

When the processor 210 is about to transmit a network packet, first, in step 310, the processor 210 controls the first network component 220 to issue a packet processing signal to the second network component 230 for driving the second network component 230 to execute a packet processing action (i.e. transmitting the network packet). Through the transmission of the packet processing signal, the first network component 220 sends the information, such as serial number, address, or length, of the network packet to the second network component 230.

In the present embodiment, besides connecting the processor 210 and the second network component 230, the first network component 220 further executes a polling action at a particular time, wherein the particular time includes the time after the first network component 220 has issued n packet processing signals (n is a positive integer). The polling action executed by the first network component 220 comprises reading the data recorded in the storage component 231, namely, the serial number of the last network packet processed by the second network component 230. The first network component 220 gets to know which network packet is currently transmitted through the execution of the polling action. For example, if the serial number recorded in the storage component 231 is 3, it means that 3 network packets have been transmitted. When the first network component 220 reads the storage component 231 again and obtains a serial number 6, it means that another 3 network packets have been transmitted during this period.

Next, in step 320, after transmitting the network packet, the second network component 230 updates the content of the storage component 231 with the serial number of the last network packet it processed and starts executing a time-out mechanism. The time-out mechanism is, for example, counting down a waiting time (for example, 50 millisecond), and the waiting time may be a predetermined value.

Finally, in step 330, if the first network component 220 does not execute the polling action during a predefined period (for example, the time for counting down the waiting time to 0) after the time-out mechanism is started, the second network component 230 issues an interrupt to the processor 210. On the contrary, if the first network component 220 executes the polling action during the predefined period, the second network component 230 stops the time-out mechanism.

As described above, the probability of the first network component 220 executing the polling action during the predefined period increases correspondingly while transmitting a large quantity of network packets. Thus, the number of interrupt generations is greatly reduced as long as no transmission error occurs. Moreover, whether all the network packets have been transmitted or not can also be determined through reading the storage component 231 by the first network component 220.

FIG. 4 is a state machine diagram of a second network component according to an embodiment of the present invention. Based on the embodiment described above, the present invention will be further described herein regarding to the states of the second network component 230. For the convenience of description, it is assumed in the present embodiment that the first network component 220 executes a polling action every time after it issues one packet processing signal to the second network component 230. Namely, the first network component 220 reads the data recorded in the storage component 231 every time after it issues one packet processing signal.

In the present embodiment, the second network component 230 enters an initial state 410 once the waiting time has been set. Here it is assumed that the first network component 220 issues a first packet processing signal to the second network component 230. Based on foregoing assumption, the first network component 220 executes a polling action after it issues the first packet processing signal.

The second network component 230 executes a packet processing action after it receives the first packet processing signal. Once the packet processing action is completed, the second network component 230 exits from the initial state 410 and enters a countdown state 420 to count down the waiting time.

If the first network component 220 issues a second packet processing signal to the second network component 230 and executes another polling action when the second network component 230 is in the countdown state 420, the second network component 230 stops counting down and returns to the initial state 410.

However, while the second network component 230 is executing the countdown action, if the first network component 220 executes no polling action until the waiting time is counted down to 0, the second network component 230 exits the countdown state 420 and enters an interrupt issuing state 430 to issue an interrupt to the processor 210. After issuing the interrupt, the second network component 230 resumes its initial state 410 again.

In other words, the second network component 230 will switch between the initial state 410 and the countdown state 420 alternatively and hardly enter the interrupt issuing state 430 as long as the first network component 220 executes the polling action enough times. That is to say, the interrupt generating method provided by the present invention greatly reduces the time of generating interrupt for processing network packages.

It should be noted that even though network packet transmission is used as an example of the packet processing action in the embodiments described above, the present invention may also be applied to other packet processing actions, such as receiving network packets, for reducing the number of interrupts, and the scope of the packet processing action is not limited in the present invention.

In overview, the interrupt generating system and method provided by the present invention have at least following advantages:
1. The number of the first network component executing the polling action increases while a large quantity of network packets are processed, thus, the probability of the second network component issuing an interrupt is reduced correspondingly. Accordingly, the efficiency of the computer system is improved.
2. The timing of the first network component executing the polling action can be set according to the actual requirement of the product. Namely, the polling action is executed after how many packet processing signals have been issued can be determined when the first network component is implemented. Accordingly, the flexibility in interrupt generation is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An interrupt generating system, comprising:
a first network component, issuing a packet processing signal, and executing a polling action at a particular time; and
a second network component, coupled to the first network component, executing a packet processing action after receiving the packet processing signal, and executing a time-out mechanism after the packet processing action is completed, wherein
the second network component generates an interrupt if the first network component executes no polling action during a predefined period after the time-out mechanism is processed.

2. The interrupt generating system as claimed in claim 1, wherein the particular time comprises the time after the first network component has issued n packet processing signals, wherein n is a positive integer.

3. The interrupt generating system as claimed in claim 1, wherein the packet processing signal comprises an address or a length of a network packet.

4. The interrupt generating system as claimed in claim 1, wherein the second network component further comprises:
a storage component, recording a serial number of a last network packet processed by the second network component.

5. The interrupt generating system as claimed in claim 4, wherein the polling action comprises reading the content of the storage component.

6. The interrupt generating system as claimed in claim 4, wherein the second network component further updates the content of the storage component with the serial number of the last network packet after finishing the packet processing action.

7. The interrupt generating system as claimed in claim 1, wherein the packet processing action comprises transmitting a network packet.

8. The interrupt generating system as claimed in claim 1, wherein the time-out mechanism comprises counting down a waiting time.

9. The interrupt generating system as claimed in claim 8, wherein the predefined period comprises the time for counting down the waiting time to 0.

10. The interrupt generating system as claimed in claim 1, wherein the second network component stops the time-out mechanism if the first network component executes the polling action during the predefined period.

11. The interrupt generating system as claimed in claim 1, wherein the first network component comprises a network card driver.

12. The interrupt generating system as claimed in claim 1, wherein the second network component comprises a network card.

13. An interrupt generating method, suitable for a computer system having a first network component and a second network component, comprising:
executing a time-out mechanism through the second network component after finishing a packet processing action; and
generating an interrupt through the second network component if the first network component does not execute a polling action during a predefined period after the time-out mechanism is processed.

14. The interrupt generating method as claimed in claim 13, wherein before the step of starting the time-out mechanism after the packet processing action is finished, the interrupt generating method further comprises:
issuing a packet processing signal through the first network component for driving the second network component to execute the packet processing action.

15. The interrupt generating method as claimed in claim 14 further comprising:
executing the polling action at a particular time through the first network component, wherein the particular time comprises the time after n packet processing signals have been issued, and n is a positive integer.

16. The interrupt generating method as claimed in claim 14, wherein the packet processing signal comprises an address or a length of a network packet.

17. The interrupt generating method as claimed in claim 13, wherein after executing the packet processing action, the second network component further performs:
updating a serial number with a last network packet processed by the second network component.

18. The interrupt generating method as claimed in claim 17, wherein the polling action comprises reading the serial number of the last network packet processed by the second network component.

19. The interrupt generating method as claimed in claim 13, wherein the packet processing action comprises transmitting a network packet.

20. The interrupt generating method as claimed in claim 13, wherein the time-out mechanism comprises counting down a waiting time.

21. The interrupt generating method as claimed in claim 20, wherein the predefined period comprises the time for counting down the waiting time to 0.

22. The interrupt generating method as claimed in claim 13, wherein after the step of starting the time-out mechanism, the interrupt generating method further comprises:
stopping the time-out mechanism through the second network component if the first network component executes the polling action during the predefined period.

23. The interrupt generating method as claimed in claim 13, wherein the first network component comprises a network card driver.

24. The interrupt generating method as claimed in claim 13, wherein the second network component comprises a network card.
